(19) United States
(12) Patent Application Publication
(10) Pub. No.: US 2019/0361537 A1
(43) Pub. Date: Nov. 28, 2019

(54) INPUT DEVICE

(71) Applicant: Panasonic Intellectual Property Management Co., Ltd., Osaka (JP)

(72) Inventors: HIROKI ETO, Osaka (JP); YASUHIRO YAMASHITA, Osaka (JP)

(21) Appl. No.: 16/531,966

(22) Filed: Aug. 5, 2019

Related U.S. Application Data
(63) Continuation of application No. PCT/JP2018/006330, filed on Feb. 22, 2018.

(30) Foreign Application Priority Data
Mar. 3, 2017 (JP) 2017-040047

(51) Int. Cl. G06F 3/02; G01D 5/24; G06F 3/038; G06F 3/023

(52) U.S. Cl. CPC G06F 3/0202; G06F 3/0234; G06F 3/038; G01D 5/24

(57) ABSTRACT

Provided is an input device including; a capacitance sensor that has an operation panel to which a detection electrode is fixed, and a capacitance detection circuit, to detect contact of a finger with the operation panel and slide operation with the finger; a push switch that is provided on a back face side of the operation panel to detect push operation on the operation panel; and a control circuit that is connected to the capacitance detection circuit and the push switch. The control circuit outputs a signal of causing a window W to perform manual opening and closing operation when the slide operation with the finger is detected, and outputs a signal of causing the window W to perform automatic fully opening and closing operation when contact of the finger with each of upper and lower end portions of the operation panel is detected and push operation on the operation panel is detected within a predetermined period of time after the contact is detected.

### CROSS-REFERENCE TO RELATED APPLICATIONS

This application is a continuation of the PCT International Application No. PCT/JP2018/006330 filed on Feb. 22, 2018, which claims the benefit of foreign priority of Japanese patent application No. 2017-040047 filed on Mar. 3, 2017, the contents all of which are incorporated herein by reference.

### TECHNICAL FIELD

The technique disclosed in the present description relates to an input device.

### BACKGROUND ART

For example, an opening and closing switch for operating vehicle electric device (electric opening and closing unit) is known as a conventional art.

PTL 1 discloses an opening and closing switch for a shade panel, including a manual mode used by sliding the switch by one step, and an automatic mode used by sliding the switch by two steps. During the manual mode, a shade panel is opened and closed while the switch is held at a slide position. During the automatic mode, the shade panel is fully opened or fully closed.

### CITATION LIST

### Patent Literature

PTL 1: Unexamined Japanese Patent Publication No. 2011-11735

### SUMMARY OF THE INVENTION

A technique disclosed in the present description is used to suppress wrong operation when electric device is caused to perform a first operation or a second operation different from the first operation.

An input device disclosed in the present description includes a capacitance sensor, a push switch, and a control circuit. The capacitance sensor includes an operation panel, and a capacitance detection circuit. The operation panel includes a first face, a second face positioned opposite to the first face, and a detection electrode being fixed. The capacitance detection circuit is electrically connected to the detection electrode. The capacitance sensor detects contact of a finger with the operation panel, and slide operation of the finger on the operation panel. The push switch is provided on the first face of the operation panel to detect push operation on the operation panel. The control circuit is electrically connected to the capacitance detection circuit and the push switch. The control circuit outputs a first control signal for causing the electric device to perform the first operation when the capacitance sensor detects slide operation with the finger. Meanwhile, the control circuit outputs a second control signal for causing the electric device to perform the second operation different from the first operation when the capacitance sensor detects contact of the finger with a predetermined position in the second face of the operation panel, and detects push operation on the operation panel with the push switch within a predetermined period of time after the detection of the contact.

According to the technique disclosed in the present description, the electric device is caused to perform the first operation with slide operation on the operation panel (detection electrode), and is caused to perform the second operation with push operation, i.e., operation different from the slide operation, on the same operation panel (detection electrode), so that wrong operation can be suppressed when the electric device is caused to perform the first operation or the second operation.

### BRIEF DESCRIPTION OF DRAWINGS

FIG. 1 is a block diagram illustrating a vehicle window opening and closing system according to a first exemplary embodiment.

FIG. 2 is a schematic diagram illustrating a positional relation between a vehicle power window and an input device.

FIG. 3 is a front view illustrating an input device.

FIG. 4 is a cross-sectional view taken along line IV-IV of FIG. 3.

FIG. 5 is a flowchart illustrating window opening and closing control using an input device.

FIG. 6 is a cross-sectional view illustrating an input device according to a second exemplary embodiment, corresponding to FIG. 4.

### DESCRIPTION OF EMBODIMENTS

Prior to describing exemplary embodiments of the present disclosure, problems of the conventional device will be briefly described. The switch of PTL 1 is configured to switch between the manual mode and the automatic mode in accordance with the number of slide steps. Thus, wrong operation may be caused such that even when the manual mode needs to be selected, the automatic mode is selected by excessively sliding the switch, for example.

Hereinafter, exemplary embodiments will be described in detail with reference to the drawings.

### First Exemplary Embodiment

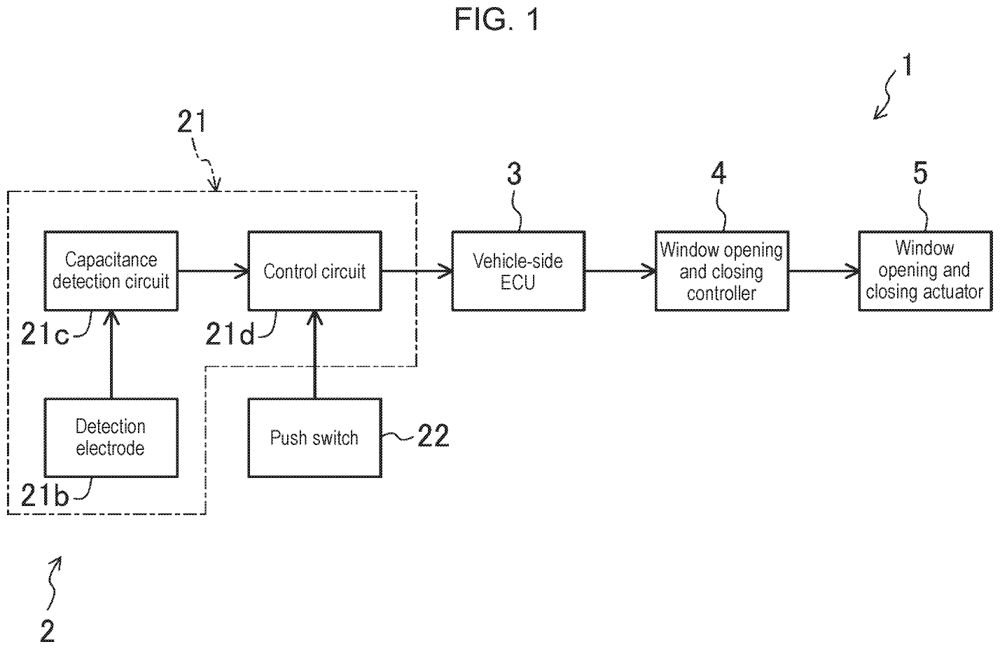

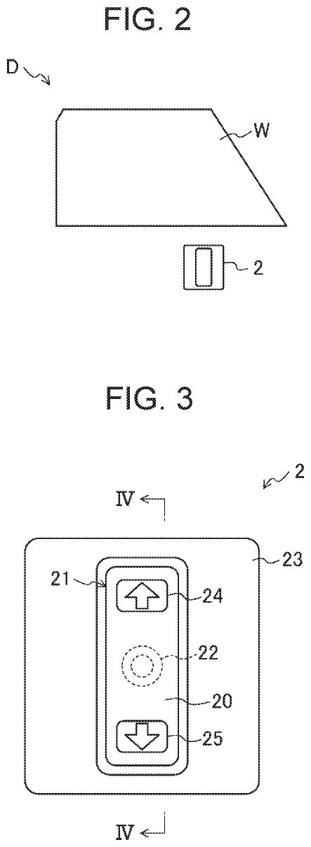

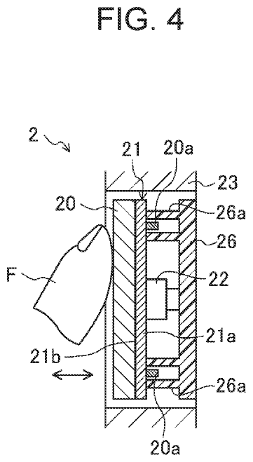

FIG. 1 is a block diagram illustrating vehicle window opening and closing system 1 mounted in a vehicle. FIG. 2 is a schematic diagram illustrating a positional relation between a vehicle power window and input device 2 of vehicle window opening and closing system 1. FIG. 3 is a front view illustrating input device 2. FIG. 4 is a cross-sectional view taken along line IV-IV of FIG. 3.

As illustrated in FIGS. 1 to 4, vehicle window opening and closing system 1 includes input device 2, vehicle-side electronic control unit (ECU) 3, window opening and closing controller 4, and window opening and closing actuator 5.

Input device 2 instructs a vehicle power window W (referred below to as simply a “window W”) being electric device to perform opening and closing operation. Input device 2 is disposed on an inner surface of vehicle door D, below the window W. Input device 2 includes operation panel 20, capacitance sensor 21, and push switch 22.

Capacitance sensor 21 detects contact of a finger F of user with operation panel 20, and slide operation of the finger F on operation panel 20, using detection electrode 21b described below. Capacitance sensor 21 includes detection electrode 21b, capacitance detection circuit 21c, and control circuit 21d.

Detection electrode 21b is formed in a rectangular shape as a whole, having a longitudinal direction aligning with a vertical direction in FIG. 3. Detection electrode 21b is composed of a plurality of electrodes (not illustrated) juxtaposed to each other in the longitudinal direction. Each of the electrodes is formed in a rectangular shape. Capacitance detection circuit 21c is electrically connected to each of the electrodes of detection electrode 21b. Capacitance detection circuit 21c detects capacitance between a conductor or a dielectric such as a finger and each of the electrodes of detection electrode 21b, and outputs a detection signal. Control circuit 21d is electrically connected to capacitance detection circuit 21c and push switch 22. Control circuit 21d outputs a control signal in accordance with output signals of capacitance detection circuit 21c and push switch 22.

Operation panel 20 is a plate member enabling push operation with the finger F in its thickness direction. Operation panel 20 is disposed inside quadrangular frame member 23, near a front face (a left face in FIG. 4) of quadrangular frame member 23. Operation panel 20 is formed in a rectangular shape having a longitudinal direction aligning with the vertical direction. Operation panel 20 is in close contact with substrate 21a. Substrate 21a is formed in a rectangular shape having a longitudinal direction aligning with the vertical direction. Substrate 21a has a size substantially equal to a size of detection electrode 21b, as viewed from its thickness direction. Substrate 21a is provided on its front face with detection electrode 21b. That is, detection electrode 21b constitutes a part of operation panel 20, and both of them are in close contact with each other and fixed. Detection electrode 21b is not necessarily in close contact with operation panel 20, and both of them may be fixed with a clearance. Operation panel 20 has an upper end portion (at a predetermined position on operation panel 20) with fully-closing button design 24 displayed, and a lower end portion (a predetermined position on operation panel 20) with fully-opening button design 25 displayed. Fully-closing button design 24 and fully-opening button design 25 are positioned on a plane substantially flush with a front face (second face) of operation panel 20. Fully-closing button design 24 has a shape of an upward arrow enclosed by a quadrangular frame. Fully-opening button design 25 has a shape of a downward arrow enclosed by a quadrangular frame.

Operation panel 20 is provided near its back face (a right face in FIG. 4, a first face) with resin panel 26 facing substrate 21a. Resin panel 26 is disposed inside quadrangular frame member 23, near a back face of quadrangular frame member 23, while being fixed. Resin panel 26 is formed in a rectangular shape having a longitudinal direction aligning with the vertical direction. Resin panel 26 has a size substantially equal to a size of substrate 21a, as viewed from its thickness direction. Resin panel 26 faces parallel to substrate 21a.

Substrate 21a and resin panel 26 are spaced from each other. Guide tubes 26a are disposed at respective places between upper and lower end portions in a back face of substrate 21a, and corresponding upper and lower end portions in a front face of resin panel 26. FIG. 4 illustrates a state where operation panel 20 is operated by push operation of the finger F, so that guide tubes 26a are in contact with substrate 21a. When the finger F does not operate the push operation, guide tubes 26a and substrate 21a are spaced from each other. Guide tubes 26a are each formed in a cylindrical shape, integrally with resin panel 26. Guide ribs 20a erected on substrate 21a are inserted into respective guide tubes 26a. When push operation is applied to operation panel 20, operation panel 20 is moved toward resin panel 26 against urging force caused by an elastic body (not illustrated) built in push switch 22. At this time, guide ribs 20a are moved in respective guide tubes 26a, so that rattling during the push operation on operation panel 20 is reduced. Meanwhile, when the push operation on operation panel 20 is finished, operation panel 20 is moved toward an opposite side of resin panel 26 by urging force caused by the elastic body built in push switch 22 to be returned to an original position.

Push switch 22 is a mechanical switch that detects push operation on operation panel 20. Push switch 22 is disposed in a central portion in the back face of substrate 21a. There is no clearance between a leading end of push switch 22 and the front face of resin panel 26. When push operation is applied to the upper end portion or the lower end portion of operation panel 20 (fully-closing button design 24 or fully-opening button design 25 formed in the front face of operation panel 20), the whole of operation panel 20 is moved toward resin panel 26 to press the leading end of push switch 22 against resin panel 26, and then push switch 22 outputs an operation signal.

Vehicle-side ECU 3 is an electronic controller that controls electric device including the window W. Vehicle-side ECU 3 is electrically connected to control circuit 21d. Vehicle-side ECU 3 outputs a control signal in accordance with an output signal of control circuit 21d. Window opening and closing controller 4 controls window opening and closing actuator 5. Window opening and closing controller 4 is electrically connected to vehicle-side ECU 3. Window opening and closing controller 4 outputs a control signal in accordance with an output signal of vehicle-side ECU 3. Window opening and closing actuator 5 opens and closes the window W. Window opening and closing actuator 5 is connected to window opening and closing controller 4. Window opening and closing actuator 5 applies opening and closing control to the window W in accordance with an output signal of window opening and closing controller 4.

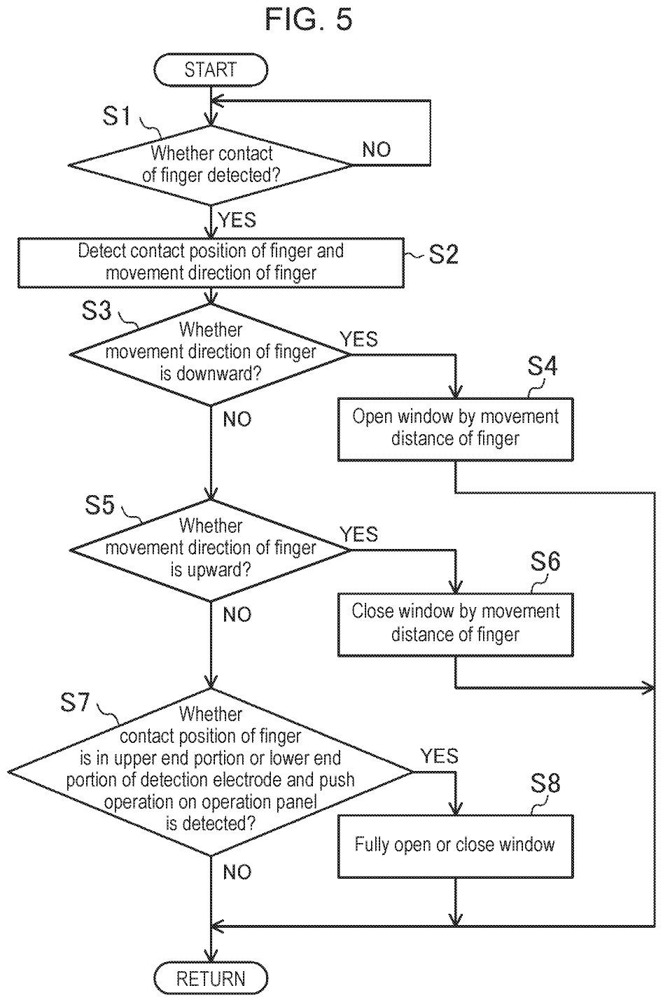

Hereinafter, window opening and closing control using input device 2 will be described with reference to the flowchart of FIG. 5.

First, in step S1, control circuit 21d determines whether contact of the finger F with operation panel 20 is detected by detection electrode 21b and capacitance detection circuit 21c. When a determination result is YES in step S1 and the contact of the finger F is detected, the window opening and closing control proceeds to step S2. When the determination result is NO in step S1 and the contact of the finger F is not yet detected, the window opening and closing control is returned to start.

In step S2, control circuit 21d detects a contact position of the finger F on operation panel 20, and a movement direction of the finger F on operation panel 20.

In subsequent step S3, control circuit 21d determines whether the movement direction of the finger F on operation panel 20 (a slide operation direction using the finger F) is a downward direction (a direction from a fully-closing button design 24 side toward fully-opening button design 25). When a determination result is YES in step S3 and the movement direction is the downward direction, the window opening and closing control proceeds to step S4. When the determination result is NO in step S3 and the movement direction is not the downward direction, the window opening and closing control proceeds to step S5.

In step S4, control circuit 21d outputs a window closing control signal (first control signal) for causing the window W to perform manual closing operation (first operation) by a distance corresponding to the movement distance of the finger F on operation panel 20. Vehicle-side ECU 3 having received the output signal outputs a window opening control signal, and window opening and closing controller 4 having received the output signal outputs a window opening control signal. Then, window opening and closing actuator 5 having received the output signal opens the window W by a distance corresponding to the movement distance of the finger F on operation panel 20. After that, the window opening and closing control is returned to the start.

In step S5, control circuit 21d determines whether the movement direction of the finger F on operation panel 20 (the slide operation direction using the finger F) is an upward direction (a direction from a fully-opening button design 25 side toward fully-closing button design 24). When the determination result is YES in step S5 and the movement direction is the upward direction, the window opening and closing control proceeds to step S6. When the determination result is NO in step S5 and the movement direction is not the upward direction (when there is no slide operation using the finger F on operation panel 20), the window opening and closing control proceeds to step S7.

In step S6, control circuit 21d outputs a window closing control signal (first control signal) for causing the window W to perform manual closing operation (first operation) by a distance corresponding to the movement distance of the finger F on operation panel 20. Vehicle-side ECU 3 having received the output signal outputs a window closing control signal, and window opening and closing controller 4 having received the output signal outputs a window closing control signal. Then, window opening and closing actuator 5 having received the output signal closes the window W by a distance corresponding to the movement distance of the finger F on operation panel 20. After that, the window opening and closing control is returned to the start.

In step S7, control circuit 21d determines whether the contact position of the finger F on operation panel 20 is in the upper end portion (fully-closing button design 24) of operation panel 20 or in the lower end portion (fully-opening button design 25), and whether push operation on operation panel 20 is detected by push switch 22 within a predetermined period of time after the contact is detected (e.g., within one second after the contact is detected). When a determination result in step S7 is YES, and the contact position of the finger F is in the upper end portion of operation panel 20 or in the lower end portion of operation panel 20 and the push operation on operation panel 20 is detected, the window opening and closing control proceeds to step S8. When the determination result in step S7 is NO (e.g., when contact of the finger F on the upper end portion or the lower end portion of operation panel 20 is wrong contact), the window opening and closing control is returned to the start.

In step S8, when the contact position of the finger F on operation panel 20 is in the upper end portion (fully-closing button design 24) of operation panel 20, control circuit 21d outputs a window fully closing control signal (second control signal) for causing the window W to perform automatic fully closing operation (second operation). When the contact position of the finger F on operation panel 20 is in the lower end portion (fully-opening button design 25) of operation panel 20, control circuit 21d outputs a window fully-opening control signal (second control signal) for causing the window W to perform automatic fully-opening operation (second operation). Vehicle-side ECU 3 having received the output signal outputs a window fully-closing control signal (or a window fully-opening control signal), and window opening and closing controller 4 having received the output signal outputs a window fully-closing control signal (or a window fully-opening control signal). Then, window opening and closing actuator 5 having received the output signal automatically fully closes the window W (or automatically fully opens the window W). After that, the window opening and closing control is returned to the start.

### Effects

As described above, according to the present exemplary embodiment, slide operation on operation panel 20 (detection electrode 21b) causes the window W to perform manual opening and closing operation, and push operation against the same operation panel 20 (detection electrode 21b), i.e., operation different from the slide operation, causes the window W to perform automatic fully opening and closing operation. Thus, wrong operation can be suppressed when the window W is caused to perform the manual opening and closing operation or the automatic fully opening and closing operation.

While the predetermined position on operation panel 20 is disposed at each of two (a plurality of) places of the upper end portion and the lower end portion of operation panel 20 in the present exemplary embodiment, only one push switch 22 is disposed. However, the present invention is not limited to the configuration as described above, and push switch 22 may be disposed at each of the two predetermined positions. That is, push switches 22 may be disposed as many as the number of predetermined positions to correspond to the predetermined positions of operation panel 20.

The finger F may be a touch pen or the like as long as it is a conductor or a dielectric.

### Second Exemplary Embodiment

The present exemplary embodiment is different in input device 2 from the first exemplary embodiment, and is similar in other structures to the first exemplary embodiment. Accordingly, in the description below, redundant description regarding components similar to the components in the first exemplary embodiment may be eliminated.

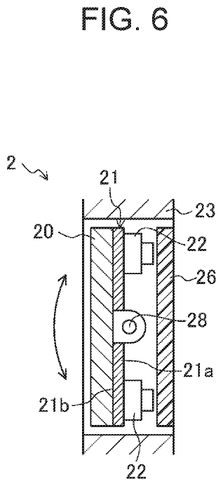

FIG. 6 is a cross-sectional view illustrating an input device, corresponding to FIG. 4. As illustrated in FIG. 6, operation panel 20 is configured to be capable of pivoting around pivot shaft 28 extending in a lateral direction (a direction passing through a paper-surface in FIG. 6) on a back face side of its central portion in its longitudinal direction.

As with the first exemplary embodiment described above, operation panel 20 has an upper end portion (at a predetermined position on operation panel 20) with fully-closing button design 24 displayed, and a lower end portion (a predetermined position on operation panel 20) with fully-opening button design 25 displayed. That is, each of the predetermined positions of operation panel 20 is in the corresponding one of end portions in a direction orthogonal to a thickness direction of operation panel 20 and an axial direction of pivot shaft 28 in operation panel 20.

Two push switches 22 are disposed corresponding to the upper end portion (fully-closing button design 24) and the lower end portion (fully-opening button design 25) of operation panel 20. There is a clearance between a leading end of each of push switches 22 and a front face of resin panel 26. There may be no clearance between both of them. When an upper end portion (fully-closing button design 24 of operation panel 20) in operation panel 20 is pushed to cause operation panel 20 to be pivoted such that an upper end side of operation panel 20 is moved more toward resin panel 26 than a lower end side thereof, a leading end of one of push switches 22, on an upper side, is pressed against resin panel 26 to cause the one of push switches 22 to output an operation signal. Meanwhile, when the lower end portion (fully-opening button design 25 of operation panel 20) in operation panel 20 is pushed to cause operation panel 20 to be pivoted such that the lower end side of operation panel 20 is moved more toward resin panel 26 than the upper end side thereof, a leading end of the other of push switches 22, on a lower side, is pressed against resin panel 26 to cause the other of push switches 22 to output an operation signal.

Unlike the first exemplary embodiment, guide rib 20a and guide tube 26a are not disposed between a back face of substrate 21a and a front face of resin panel 26.

Window opening and closing control using input device 2 is similar to that in the first exemplary embodiment.

### Effects

As described above, according to the present exemplary embodiment, operation effects similar to those in the first exemplary embodiment can be obtained.

A total of two push switches 22 are each disposed corresponding to one of an upper end portion and a lower end portion (a plurality of predetermined positions) in operation panel 20, so that push operation on operation panel 20 can be reliably detected.

Operation panel 20 is pivoted around pivot shaft 28 by pushing the upper end portion or the lower end portion of operation panel 20, so that push operational feeling on operation panel 20 can be improved.

### Other Exemplary Embodiments

While in each of the exemplary embodiments described above, input device 2 is used for opening and closing control of the vehicle window W, besides this, input device 2 may be used for opening and closing control or the like of electric device required to perform manual opening and closing operation, and automatic opening and closing operation, such as opening and closing control of a vehicle electric sunroof, opening and closing control of a vehicle electric curtain, or opening and closing control of a residential electric curtain, for example.

While in each of the exemplary embodiments described above, fully-closing button design 24 is disposed in the upper end portion of operation panel 20, and fully-opening button design 25 is disposed in the lower end portion of operation panel 20, each of them may be disposed in another portion of operation panel 20. In addition, operation panel 20 may be formed in a rectangular shape having a longitudinal direction aligning with the lateral direction of FIG. 3, in which fully-closing button design 24 may be disposed in an upper end portion (one end portion in the lateral direction) of operation panel 20, and fully-opening button design 25 may be disposed in a lower end portion (the other end portion in the lateral direction) of operation panel 20.

The components in each of the exemplary embodiments described above may be combined, as appropriate, without departing from the scope of the technique disclosed in the present description.

### INDUSTRIAL APPLICABILITY

As described above, the technique disclosed in the present description can be used for an input device and the like.

### REFERENCE MARKS IN THE DRAWINGS

1 vehicle window opening and closing system
2 input device
20 operation panel
20a guide rib
21 capacitance sensor
21a substrate
21b detection electrode
21c capacitance detection circuit
21d control circuit
22 push switch
23 quadrangular frame member
24 fully-closing button design
25 fully-opening button design
26 resin panel
26a guide tube
28 pivot shaft
D vehicle door
F finger of user
W vehicle power window (electric device)

1. An input device comprising:
a capacitance sensor;
a push switch; and
a control circuit,
wherein
the capacitance sensor includes an operation panel, and a capacitance detection circuit,
the operation panel includes a first face, a second face positioned opposite to the first face, and a detection electrode being fixed,
the capacitance detection circuit is electrically connected to the detection electrode,
the capacitance sensor detects contact of a finger with the operation panel, and slide operation of the finger on the operation panel,
the push switch is provided on the first face of the operation panel and detects push operation on the operation panel,
the control circuit is electrically connected to the capacitance detection circuit and the push switch, and
the control circuit outputs a first control signal for causing an electric device to perform the first operation when the capacitance sensor detects slide operation with the finger, and the control circuit outputs a second control signal for causing the electric device to perform the second operation different from the first operation when the capacitance sensor detects contact of the finger with a predetermined position in the second face of the operation panel, and detects push operation on the operation panel with the push switch within a predetermined period of time after the detection of the contact.

2. The input device according to claim 1, wherein
the predetermined position in the operation panel is one of a plurality of predetermined positions,
the push switch is one of a plurality of push switches,
and the plurality of the push switches are disposed as many as the predetermined positions to correspond to the predetermined positions of operation panel.

3. The input device according to claim 1, wherein
the operation panel is configured to pivot around a pivot shaft in a central portion of the operation panel,
the predetermined position in the operation panel is one of a plurality of predetermined positions, and is in each of end portions in the operation panel, in a direction orthogonal to a thickness direction of the operation panel and the an axial direction of the pivot shaft, and
the push switch is disposed corresponding to each of the plurality of predetermined positions in the operation panel.

4. An input device comprising:
a capacitance sensor;
a push switch; and
a control circuit,
wherein
the capacitance sensor includes an operation panel, and a capacitance detection circuit,
the operation panel includes a first face, and a second face positioned opposite to the first face, and a detection electrode is fixed to the first face,
the capacitance detection circuit is electrically connected to the detection electrode,
the capacitance sensor detects contact of a conductor or a dielectric with the operation panel, and slide operation of the conductor or the dielectric on the operation panel,
the push switch is provided on the first face of the operation panel and detects push operation on the operation panel,
the control circuit is electrically connected to the capacitance detection circuit and the push switch, and
the control circuit outputs a first control signal for causing an electric device to perform the first operation when the capacitance sensor detects slide operation with the conductor or the dielectric, and the control circuit outputs a second control signal for causing the electric device to perform the second operation different from the first operation when the capacitance sensor detects contact of the conductor or the dielectric with a predetermined position in the second face of the operation panel, and detects push operation on the operation panel with the push switch within a predetermined period of time after the detection of the contact with the predetermined position in the second face.

5. A vehicle window opening and closing system comprising an input device to control opening and closing of a window of a vehicle in accordance with input from the input device,
the input device including:
a capacitance sensor;
a push switch; and
a control circuit,
wherein
the capacitance sensor includes an operation panel, and a capacitance detection circuit,
the operation panel includes a first face, and a second face positioned opposite to the first face, and a detection electrode is fixed to the first face,
the capacitance detection circuit is electrically connected to the detection electrode,
the capacitance sensor detects contact of a conductor or a dielectric with the operation panel, and slide operation of the conductor or the dielectric on the operation panel,
the push switch is provided on the first face of the operation panel and detects push operation on the operation panel,
the control circuit is electrically connected to the capacitance detection circuit and the push switch, and
the control circuit outputs a first control signal for causing an electric device to perform the first operation when the capacitance sensor detects slide operation with the conductor or the dielectric, and the control circuit outputs a second control signal for causing the electric device to perform the second operation different from the first operation when the capacitance sensor detects contact of the conductor or the dielectric with a predetermined position in the second face of the operation panel, and detects push operation on the operation panel with the push switch within a predetermined period of time after the detection of the contact with the predetermined position in the second face,
the input device being disposed on an inner surface near the window of the vehicle,
the first operation causing the window to be moved in a direction substantially identical to a movement direction of the conductor or the dielectric in the slide operation, and
the second operation causing the window to be fully opened or fully closed corresponding to the predetermined position of the conductor or the dielectric.

6. The vehicle window opening and closing system according to claim 5, wherein the first operation causes the window to be moved in accordance with a movement distance of the conductor or the dielectric in the slide operation.

7. The vehicle window opening and closing system according to claim 5,
the input device being disposed on an inner surface of a door of the vehicle, below the window.
